(19) United States
(12) Patent Application Publication
(10) Pub. No.: US 2003/0117983 A1
(43) Pub. Date: Jun. 26, 2003

(54) Method and gateway GPRS support node (GGSN) for user (payload) plane redundancy

(76) Inventors: Bobby That Dao Ton, Lachine (CA); Tormod Hegdahl, Oslo (NO); Lev Deich, Brossard (CA)

Correspondence Address: SANDRA BEAUCHESNE, Ericsson Canada Inc., Patent Department (LMC/UP), 8400 Decarie Blvd., Town Mount Royal, QC, H4P 2N2, CA

(21) Appl. No.: 10/025,631

(22) Filed: Dec. 26, 2001

(51) Int. Cl. H04L 1/00

(52) U.S. Cl. 370/338; 370/353

(57) ABSTRACT

A GPRS Support Node (GGSN) has a plurality of user plane (data session) processing units (GTP-Us) for handling data sessions for Mobile Stations (MSs), a plurality of controlling units (GTP-C/s) for controlling the data sessions payloads, and a master data session control unit (GTP-C/m) dispatching data sessions requests to GTP-C/s. When a GTP-U goes down, the GTP-C/m detects the failure. If no spare GTP-U is available, the GTP-C/m removes internal connections related to the failed data sessions, and instructs all the GTP-C/s that controlled data sessions lost on the failed GTP-U to delete the PDP contexts of those sessions, and requests a Route update from the Routing Engine (RE). If a spare GTP-U is available, the GTP-C/m activates the spare GTP-U, and requests every GTP-C/s that controlled data sessions on the failed GTP-U to rebuild these sessions on the spare GTP-U unit. Following completion of the rebuild, it requests a Route update from the RE.

### BACKGROUND OF THE INVENTION

1. Field of the Invention

The present invention relates to GPRS networks, and in particular to a Gateway GPRS Support Node (GGSN).

2. Description of the Related Art

General Packet Radio Services (GPRS) is a packet-based wireless communication service that offers higher rates and continuous connection to an IP data network for mobile phone and computer users. The higher data rates allow users to take part in videoconferences and interact with multimedia Web sites and similar applications using mobile terminal devices as well as notebook computers. GPRS is an evolution of the Global System for Mobile (GSM) communications and complements existing services such as the circuit-switched cellular phone connections and the Short Message Service (SMS).

In GPRS packet-based service communication channels are used on a shared-use, as-packets-are-needed basis rather than dedicated only to one user at a time. As GPRS becomes available, mobile users of a virtual private network VPN are able to access privates network continuously rather than through a dial-up connection. GPRS also complements Bluetooth, a standard for replacing wired connections between devices with wireless radio connections. GPRS is an evolutionary step toward the Third Generation (3G) Enhanced Data GSM Environment (EDGE) and Universal Mobile Telephone Service (UMTS).

Reference is now made to FIG. 1 (Prior Art), which shows a high-level logical architecture diagram of a typical GPRS network 100, with the standard accepted nodes, functionalities and interfaces. The functioning of the illustrated network is known in the art, as described in the Third Generation Partnership Project (3GPP)' GPRS standards Release 99, herein included by reference. For example, shown in FIG. 1 is a Serving GPRS Support Node (SGSN) 102 that provides the direct access point for GPRS-based terminals, subtending from one or more Gateway GPRS Support Nodes (GGSNs) 104ᵢ, that provide the gateway to the SGSN across mobile networks that the user may visit. The GGSNs 104ᵢ are one of the key components of GPRS core network, being the anchor points for the mobile GPRS terminals to which they provide support for seamless IP connectivity. The GGSNs support access for the Mobile Stations (MS) towards multiple Paket-Data networks (PDN), such as for corporate/ISPs (Internet Service Providers) 108, by using Virtual Private Network (VPN) technologies. Corporate/ISP selection by the MS, utilise the Access Point Name (APN) information element to create GPRS Tunnelling Protocol (GTP) message such as defined in the Third Generation Partnership Project (3GPP) Technical Specification (TS) 29.060 of Release 99, and in the GSM 09.60 of same Release 99, both of which are herein included by reference, in the setting up of sessions through the GPRS network. The communications between the MS 106 and the GGSN 104 are connection oriented and hence continuous support of a GTP data session in the GGSN is of utmost importance for the user's service acceptance. The GGSN receives IP datagrams routed to the Packet Data Protocol (PDP) address of any of its connected MSs, and tunnels those IP datagrams for delivery to the MS via the GTP tunnel (i.e. through the SGSN). The GGSN is connected to the SGSN via an IP backbone.

Therefore, the availability of the GGSN is critical for the continuous provision of data services in the GPRS network. However, the existing platforms on which the GGSN functionality is implemented do not provide platform redundancy. Consequently, in current GGSN implementations, in case of failure of a software module, or of a hardware component of the GGSN, the GPRS/UMTS service is interrupted until the failed GGSN recovers.

Accordingly, it should be readily appreciated that in order to overcome the deficiencies and shortcomings of the existing solutions, it would be advantageous to have a GGSN having a distributed architecture allowing a user (data payload) plane redundancy that avoids the total collapse of the GGSN in case a given hardware or software component of the GGSN experiences a failure. The present invention provides such a method and system.

### SUMMARY OF THE INVENTION

In one aspect, the present invention is method for releasing Packet Data Protocol (PDP) contexts relating to data sessions held by a data processing unit (GTP-U) of a Gateway General Packet Radio Service (GPRS) Support Node (GGSN) having a plurality of data processing units (GTP-Us), the method comprising the steps of:

i) detecting a failure or a shutdown of one of the GTP-Us;

ii) detecting at least one control unit (GTP-C/s) that controlled data sessions supported by the failed or shutdown GTP-U; and

iii) deleting on the at least one GTP-C/s the PDP Context related to the data sessions supported by the failed or shutdown GTP-U.

In another aspect, the present invention is a a Gateway General Packet Radio Service (GPRS) Support Node (GGSN) comprising:

a plurality of data sessions processing units (GTP-Us) for supporting data sessions for mobile terminals;

a plurality of data session control units (GTP-C/s) for controlling the data sessions;

a master control unit (GTP-C/m) of the GGSN detecting a failure or a shutdown of one of the GTP-Us;

wherein the GTP-C/m detects at least one GTP-C/s that controlled data sessions supported by the failed or shutdown GTP-U, and requests deletion of the PDP Context related to the data sessions supported by the failed or shutdown GTP-U on each one of the at least one GTP-C/s.

In yet another aspect, the present invention is a method for replacing a failed data session processing unit (GTP-U) supporting one or more data sessions for mobile terminals on a Gateway General Packet Radio Service (GPRS) Support Node (GGSN), the method comprising the steps of:

i) detecting a failure or a shutdown of the GTP-U of the GGSN;

ii) activating a spare GTP-U of the GGSN; and

iii) rebuilding the plurality of data sessions on the spare GTP-U.

In yet another aspect, the present invention is a Gateway General Packet Radio Service (GPRS) Support Node (GGSN) comprising:

a plurality of data sessions processing units (GTP-Us) for supporting one or more data sessions for mobile terminals;

a plurality of data session control units (GTP-C/s) for controlling the one or more data sessions;

a master control unit (GTP-C/m) of the GGSN detecting a failure or a shutdown of one of the GTP-Us;

wherein when the GTP-C/m detects the failure or the shutdown of one of the GTP-Us, it activates a spare GTP-U of the GGSN and instructs rebuilding the one or more data sessions on the spare GTP-U.

### BRIEF DESCRIPTION OF THE DRAWINGS

For a more detailed understanding of the invention, for further objects and advantages thereof, reference can now be made to the following description, taken in conjunction with the accompanying drawings, in which:

FIG. 1 (Prior Art) is a high-level logical architecture diagram of a typical GPRS network as it is known in the prior art;

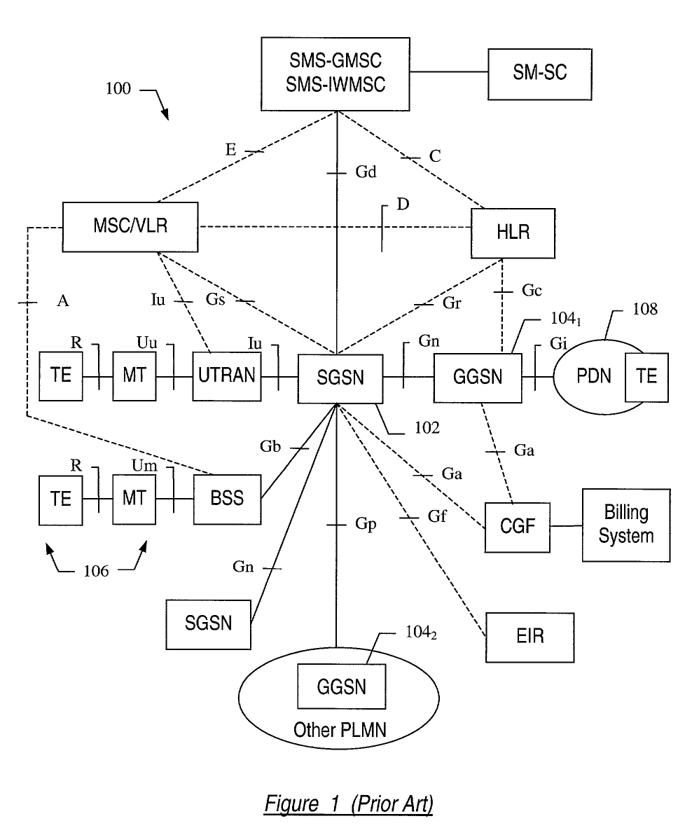

FIG. 2 is an exemplary nodal architecture diagram of a Gateway GPRS Support Node (GGSN) according to the preferred embodiment of the invention;

FIG. 3 is an exemplary nodal operation and signal flow diagram of one aspect of the preferred embodiment of the invention; and

FIG. 4 is another exemplary nodal operation and signal flow diagram of another aspect of the preferred embodiment of the invention; and

### DETAILED DESCRIPTION OF THE PREFERRED EMBODIMENTS

The innovative teachings of the present invention will be described with particular reference to numerous exemplary embodiments. However, it should be understood that this class of embodiments provides only a few examples of the many advantageous uses of the innovative teachings of the invention. In general, statements made in the specification of the present application do not necessarily limit any of the various claimed aspects of the present invention. Moreover, some statements may apply to some inventive features but not to others. In the drawings, like or similar elements are designated with identical reference numerals throughout the several views, and the various elements depicted are not necessarily drawn to scale.

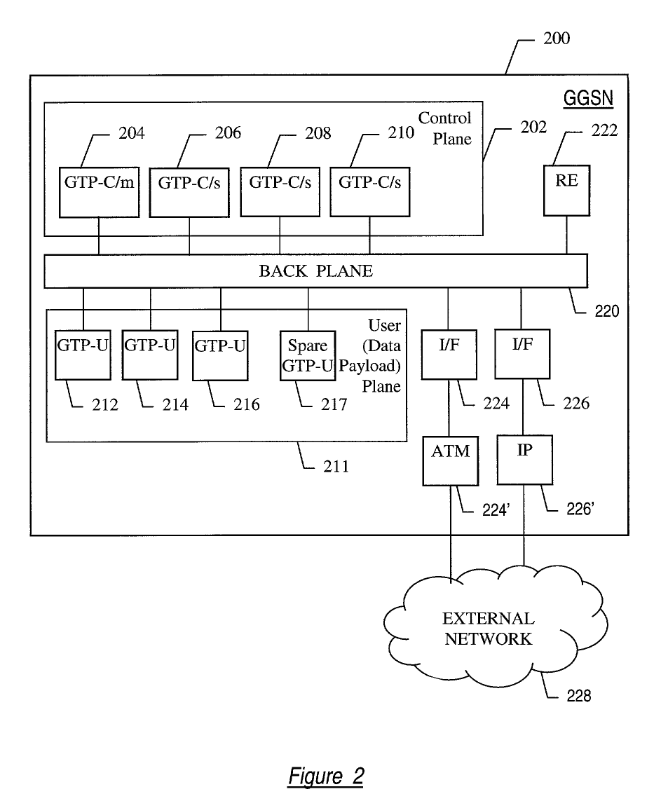

Referring now to FIG. 2, depicted therein is an exemplary nodal architecture diagram of a Gateway GPRS Support Node (GGSN) 200 according to the preferred embodiment of the invention. The GGSN 200 comprises a distributed GGSN control plane functionality (GTP-C) 202 having multiple control processing units (GTP-Cs) 204-210 for communication sessions control handling. Preferably, the GTP-Cs are processing cards that control one or more Point-to-Point Protocol (PPP) data sessions for mobile terminals. Their main functions include charging (billing), processing the create GPRS Tunnelling Protocol (GTP) control messages related to each data session they control, and providing a Remote Authentication Dial-In User Server/Service (RADIUS) interface for user authentication. The GGSN 200 further includes a user plane (data payload) distributed functionality 211 comprising i) multiple user plane (data payload) processing units (GTP-Us) 212-216, which functions include handling the data sessions payload and the GTP tunnelling and de-tunnelling for each data session they handle, and, optionally, ii) a spare, non-utilized, GTP-U unit 217 that runs in a stand-by mode and is ready for taking over the data session processing tasks of a failed GTP-U unit. This distributed architecture provides reliability and scalability to the GGSN 200, and hence reduces the service downtime in case of a single point of failure in one of the GTP-Cs. The GGSN 200 further includes a back-plane 220 acting as a communications bus connecting the different components of the GGSN 200. A Routing Engine (RE) 222 is responsible for managing a routing table (not shown) allowing the correct internal signalling and communications between the different components of the GGSN 200. Communications interfaces I/F 224 and 226 provide access for the GGSN 200 to external networks 228 selected by the users, or to cooperating GGSNs.

According to the present invention, the GGSN 200 provides support for load balancing and control task distribution between the active GTP-Cs, as it also provides support for load balancing and data sessions distribution between the active GTP-Us. A centralized PDP context management for the whole GGSN control plane offers an efficient method for load balancing and redundancy. Accordingly, all primary PDP contexts create requests are addressed to a master GTP-C unit (GTP-C/m) 204, which thereafter dynamically dispatches the request messages to other slave GTP-Cs (GTP-C/s) 206-210. Subsequent communications for the same link (Primary PDP context and associated secondary PDP context) between a served Mobile Station (MS) and the GGSN 200 are directly addressed to the appropriate GTP-C/s by utilising a GGSN address for control plane information element in the GTP create response message, formatted for example according to the Third Generation Partnership Project (3GPP) Technical Specification (TS) 29.060/GSM 09.060, herein included by reference.

The GTP-C/m and GTP-C/s can use broadcast, multicast messages or similar mechanism to exchange information with each other and between the unit boards for the support of load balancing and GTP-C redundancy. According to the invention, the heartbeat message exchange may have two sets of information with different urgency. First a keep-alive information is used to update cooperating units within less then, for example, 100 milliseconds at both hardware or software failure. The keep-alive information is used to detect addition, removal and failure on the boards of the node. Second, load information may be updated with a frequency of every more or less 1 second to distribute load information from the GTP-C/s and GTP-Us. For efficiency purposes, according to the invention, the keep alive message exchange may be handled on low software level (kernel) in each board and may only be reported to a higher level supervision function (not shown), for actions, at an addition, removal and/or failure situation in the other parts of the node. The load information, reported with less frequency includes relevant load information for the processor units, is periodically distributed between all the GTP-C/s 216-210 and also to the GTP-C/m 204 to indicate their current individual load. The GTP-C/m 204 and each GTP-C/s 206-210 keep the load information from other GTP-C/s locally. The GTP-C/m 204 also keeps the load information from the GTP-Us 212-216. For example, the local load information may contain at least the following fields per processor unit:

1. GTP-C/s Identifier (IP address or GTP-C other ID internally used to uniquely identify a board);

2. Current number of active PDP contexts and/or CPU utilisation (memory utilisation, average present queue length, average present CPU load);

3. Expected maximum capacity or hardware version number;

4. Unit Restart and rebuild information;

The GTP-C/m stores a minimum set of information related to the PDP context in such a way that the GTP-C/s information can be re-build in combination with the information stored on the GTP-U, when such a GTP-C/s unit fails, in a manner yet to be described.

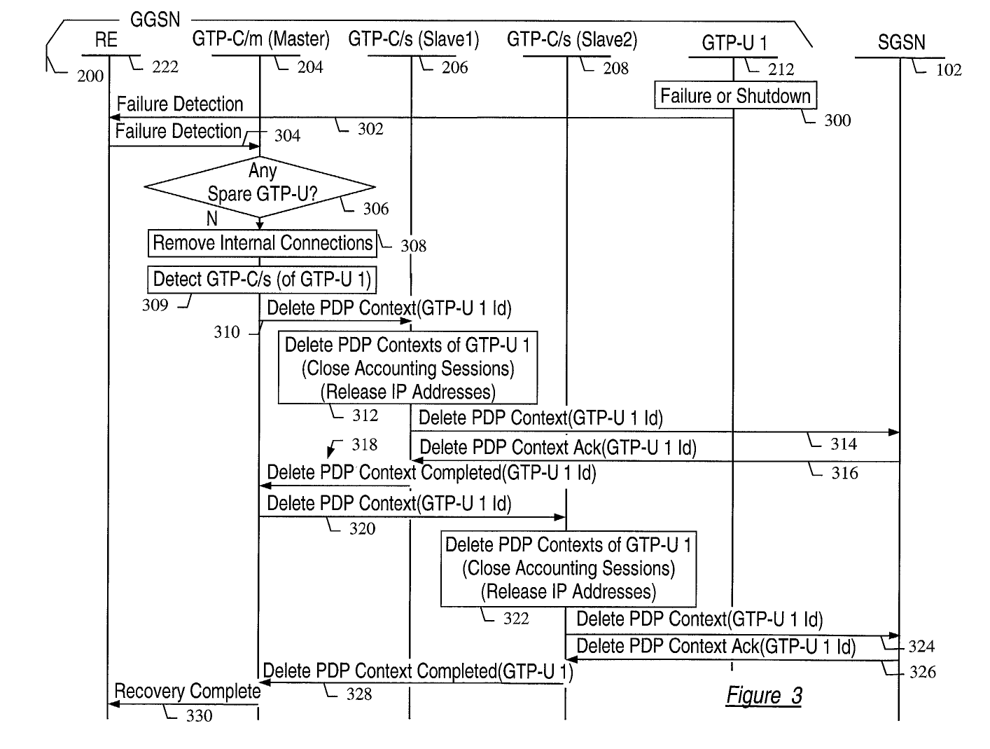

Reference is now made to FIG. 3, wherein there is shown an exemplary nodal operation and signal flow diagram of one aspect of the preferred embodiment of the invention directed to a recovery scheme of a failed data session payload processing unit (GTP-U) unit of the User Plane functionality 211 of the GGSN 200 that do not comprise a spare, non-utilized GTP-U unit. In FIG. 3, the shown exemplary nodal operation and signal flow diagram illustrates the same GGSN 200 having the same components as those described with reference to FIG. 2 (with the exception of the spare GTP-U which is not present in FIG. 3), and a Service GPRS Support Node (SGSN) 102 supporting, in cooperation with the GGSN 200, the provision of data sessions for Mobile Terminals (MTs, not shown). At the beginning, it is assumed that the GGSN 200 functions normally, wherein each GTP-C/s unit control one or more data communications sessions, which payload is processed by a corresponding GTP-U. At one point in time, one of the active GTP-U units, such as for example the GTP-U 1 212 experiences a failure, or for a given reason is shut down by the operator, action 300. Following the failure, via the heartbeat (keep-alive) signal sent by the other GTP-U or GTP-C/m units, or because of the lack of heartbeat signal (keep-alive) sent by the failed GTP-U 1 212, the RE 222 is informed of the failure or shutdown of the GTP-U 212, action 302, which in turn informs the GTP-C/m (master) unit 204, action 304. Once the GTP-C/m 204 detects or is informed that the GTP-U 212 is down, in action 306, the GTP-C/m 204 detects whether or not there is any spare, non-utilized, GTP-U that may take over the data processing tasks of the failed GTP-U and, in the present exemplary scenario, detects that there is no spare GTP-U unit available in the GGSN 200. Therefore, since there is no spare GTP-U unit for taking over the data sessions previously handled by the failed GTP-U 212, the GTP-C/m 204 removes all internal connections relating to the failed GTP-U, action 308, which may comprise the action of deleting the routes associated with the data sessions lost on the failed GTP-U 212. Then, the GTP-C/m 204 instructs deletion of all PDP contexts supported by the failed GTP-U 212. For this purpose, the GTP-C/m detects in action 309 every GTP-C/s unit that controls data sessions held by the failed GTP-U 212. In the present scenario, it is assumed that the GTP-C/s 206 and 208 controlled data sessions supported by the failed GTP-U. Therefore, the first GTP-C/s contacted (from the two GTP-C/s 206 and 206) is the GTP-C/s 206 to which the GTP-C/m 204 sends a Delete PDP Context message with a parameter identifying the failed GTP-U, for requesting the GTP-C/s 206 to delete all PDP Contexts related to that failed GTP-U 1 212, which the GTP-C/s does in action 312. This action may further comprise closing all accounting sessions and releasing all IP addresses involved in the data sessions supported by the failed GTP-U. The GTP-C/s 206 may further signal the SGSN 102 that supported (in combination with the GGSN 200) those data sessions with the mobile terminals (not shown in FIG. 3) to request deletion by the SGSN of the given PDP contexts of the failed GTP-U 212, via one or more Delete PDP Context Request message 314 comprising the identity of the PDP Context to be deleted. In some implementations, a Delete PDP Context message 314 is sent for each PDP Context to be deleted by the SGSN 102. The SGSN 102 responds with a Delete PDP Context Acknowledgement message 316 following execution each of the requests. The GTP-C/s 206 then reports to the GTP-C/m 204 the completion of the PDP Context deletion, via a Delete PDP Context Completed message 318. Equivalent steps 320-328, similar to previously described steps 310-318, are also performed for the other GTP-C/s unit 208 that held PDP Contexts for the data sessions supported by the failed GTP-U 212. Once all the GTP-C/s (GTP-C/s 206 and 208 in the illustrated exemplary scenario) report to the GTP-C/m 204 completion of the PDP context deletion, the former signals the RE 222 with a Recovery Complete message for informing of the completion of the procedure of closing the PDP Contexts of the data sessions lost in action 300.

Based upon the foregoing, it should now be apparent to those of ordinary skill in the art that the present invention provides an advantageous solution, which allows seamless closure of all PDP contexts held in GTP-C/s unit controlling data sessions of a failed GTP-U unit, in instances of failure or shutdown of one active GTP-U unit of the GGSN. Further, the present invention provides an advantageous scheme wherein most of the data communications sessions held by the plurality of GTP-U units of the GGSN 200 are kept alive in case of a single point of failure of just one of the GTP-U units, and wherein only those data communications sessions controlled by the failed GTP-U are lost.

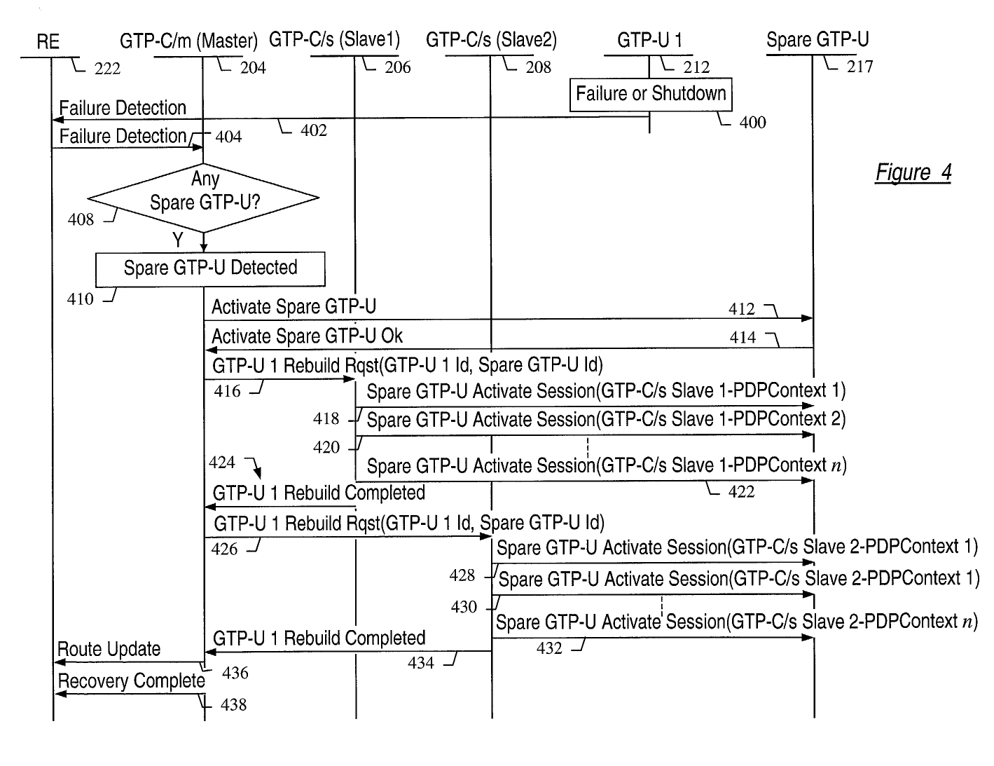

Reference is now made to FIG. 4, wherein there is shown an exemplary nodal operation and signal flow diagram of another aspect of the preferred embodiment of the invention directed to a recovery scheme following the failure of a GTP-U unit 212 of the GGSN 200 that has a spare, non-utilized GTP-U unit 217 which originally runs in a stand-by mode, without processing any data sessions, (ready to be used) and that is identified by the GTP-C/m 204 as a spare GTP-U. In FIG. 4, the shown exemplary nodal operation and signal flow diagram illustrates the same GGSN 200 having the same components as those described with reference to FIG. 3. At the beginning, it is assumed that the GGSN 200 functions normally by supporting a number of data communications sessions, as described hereinbefore. At one point in time, one of the active GTP-U units, such as for example the GTP-U unit 212 experiences a failure, or for a given reason is shut down by the operator, action 400. Following the failure or shutdown 400, via the heartbeat (keep-alive) signal sent by the other GTP-C units, or because of the lack of heartbeat signal (keep-alive) sent by the failed GTP-U unit 212, the RE 222 is informed of the failure or shutdown of the GTP-C 212, action 402, and in turn informs the GTP-C/m 204 of the fact the GTP-U 1 212 is down, action 404. Once the GTP-C/m 204 is informed that the GTP-U 212 is down, in action 408, the GTP-C/m 204 may detect whether or not there is any spare GTP-U unit available in the GGSN 200 that may take over the tasks of the failed GTP-U, and in the present exemplary scenario, detects that there is one spare GTP-U unit 217 available in the GGSN 200. As a consequence, the GTP-C/m 204 activates the spare GTP-U 217 by sending an Activate Spare GTP-U request message 412. The activation of the spare GTP-U involves for example assigning the IP address of the failed GTP-U 212, as well as the role of active GTP-U, to the spare GTP-U 217. Once its activation completed, the spare GTP-U 217 responds to the GTP-C/m with an Activate Ok message 414. The GTP-C/m 204 next contacts every GTP-C/s unit that controls data sessions held by the failed GTP-U 212 for requesting rebuild of the data sessions lost in the failure of the GTP-U 1 212 on the spare GTP-U 217. In the present scenario, it is assumed that only the shown GTP-C/s 206 and 208 controlled data sessions supported by the failed GTP-U. Therefore, the GTP-C/m sends a GTP-U Rebuild Request message 416 to the GTP-C/s 206, the message comprising a first parameter identifying which data session are to be rebuilt (the failed GTP-U identification), and a second parameter identifying where the data sessions are to be rebuilt (the spare GTP-U identification). Upon receipt of message 416, the GTP-C/s 206 sends to the spare GTP-U 217, in messages 418-422, a Spare GTP-U Activate Session request message for each one of the PDP Contexts it held for data sessions previously held by the failed GTP-U 212, thus instructing the spare GTP-U to activate new data sessions for those PDP Contexts. Once activation of these new data sessions is completed by the spare GTP-U 217, the former returns to the GTP-C/m 204 a GTP-U 1 Rebuild Completed message 424. Equivalent steps 426-434, similar the previously described steps 416-424, are also performed for the second GTP-C/s 208 that had PDP contexts for failed data sessions previously provisioned by the GTP-U 212 that failed. Finally, once all the GTP-C/s (in the present example GTP-C/s 206 and 208) report completion of the rebuild of the data sessions to the GTP-C/m 204, the former sends a Route Update message 436 to the RE 222 for updating the routes to the data sessions held by the failed GTP-U 212. Then, the GTP-C/m 204 sends a Recovery Complete message to the RE 222 for informing of the completion of the recovery process.

Based upon the foregoing, it should now be apparent to those of ordinary skill in the art that the present invention provides an advantageous solution, which offers GTP-U redundancy, by quickly activating a spare, non-utilized, GTP-U unit as an active GTP-U unit in instances of failure or shutdown of one of the active GTP-U units of the GGSN. Further, the present invention provides an advantageous scheme wherein all the data communications sessions held by the GGSN 200 are kept alive in case of a single point of failure of one GTP-U.

Although the system and method of the present invention have been described in particular reference to certain radio telecommunications messaging standards, it should be realized upon reference hereto that the innovative teachings contained herein are not necessarily limited thereto and may be implemented advantageously with any applicable radio telecommunications standard. It is believed that the operation and construction of the present invention will be apparent from the foregoing description. The method and system shown and described have are provided as exemplary embodiments of the invention, it will be readily apparent that various changes and modifications could be made therein without departing from the scope of the invention as defined by the claims set forth hereinbelow. For example, while the invention has been described with a given number of GTP-C/s units and GTP-U units, it is understood that this number may vary according to the needs of a given GGSN implementation.

Although several preferred embodiments of the method and system of the present invention have been illustrated in the accompanying Drawings and described in the foregoing Detailed Description, it will be understood that the invention is not limited to the embodiments disclosed, but is capable of numerous rearrangements, modifications and substitutions without departing from the spirit of the invention as set forth and defined by the following claims.

What is claimed is:

1. A method for releasing Packet Data Protocol (PDP) contexts relating to data sessions held by a data processing unit (GTP-U) of a Gateway General Packet Radio Service (GPRS) Support Node (GGSN) having a plurality of data processing units (GTP-Us), the method comprising the steps of:
i) detecting a failure or a shutdown of one of the GTP-Us;
ii) detecting at least one control unit (GTP-C/s) that controlled data sessions supported by the failed or shutdown GTP-U; and
iii) deleting on the at least one GTP-C/s the PDP Context related to the data sessions supported by the failed or shutdown GTP-U.

2. The method claimed in claim 1, wherein the step of detecting a failure or a shutdown of one of the GTP-Us is performed at least partially by a master control unit (GTP-C/m) of the GGSN.

3. The method claimed in claim 2, the method further comprising, following the step of detecting, the step of:
the GTP-C/m removing all its internal connections related to the failed or shutdown GTP-U.

4. The method claimed in claim 1, further comprising the steps of:
detecting if the GGSN comprises a spare, non-utilized, GTP-U unit; and
if the GGSN does not comprise a spare, non-utilized, GTP-U unit, performing steps ii) and iii).

5. The method claimed in claim 2, wherein step iii) comprises the step of:
iv) sending a Delete PDP Context request message from the GTP-C/m to each one of the at least one GTP-C/s, the request message instructing each one of the at least one GTP-C/s to delete the PDP Contexts related to the failed or shutdown GTP-U.

6. The method claimed in claim 5, wherein step iv) further comprises the step of:
sending a Delete PDP Context request message from each one of the at least one GTP-C/s to a Service GRPS support node associated with the GGSN for providing the data session for mobile terminals, the request message instructing the GPRS to delete one or more PDP Contexts related to the failed or shutdown GTP-U.

7. The method claimed in claim 2, further comprising, following step iii), the step of:
sending a Route Update request from the GTP-C/m to a Routing Engine (RE) for requesting a route update of routes related to lost data sessions supported by the failed or shutdown GTP-U.

8. A Gateway General Packet Radio Service (GPRS) Support Node (GGSN) comprising:
a plurality of data sessions processing units (GTP-Us) for supporting data sessions for mobile terminals;
a plurality of data session control units (GTP-C/s) for controlling the data sessions;
a master control unit (GTP-C/m) of the GGSN detecting a failure or a shutdown of one of the GTP-Us;
wherein the GTP-C/m detects at least one GTP-C/s that controlled data sessions supported by the failed or shutdown GTP-U, and requests deletion of the PDP Context related to the data sessions supported by the failed or shutdown GTP-U the at least one GTP-C/s.

9. The GGSN claimed in claim 8, wherein after it detects the failure or the shutdown of the GTP-U, the GTP-C/m removes all its internal connections related to the failed or shutdown GTP-U.

10. The GGSN claimed in claim 8, wherein the GTP-C/m detects if the GGSN comprises a spare, non-utilized, GTP-U unit, and if the GGSN does not comprise a spare, non-utilized, GTP-U unit, the GTP-C/m detects at least one GTP-C/s that controlled data sessions supported by the failed or shutdown GTP-U, and requests deletion of the PDP Context related to the data sessions supported by the failed or shutdown GTP-U on the at least one GTP-C/s.

11. The GGSN claimed in claim 8, wherein the GTP-C/m sends a Delete PDP Context request message to each one of the at least one GTP-C/s, the request message instructing the at least one GTP-C/s to delete the PDP Contexts related to the failed or shutdown GTP-U.

12. The GGSN claimed in claim 11, wherein each one of the at least one GTP-C/s send a Delete PDP Context request message to a Service GRPS support node associated with the GGSN for providing the data session for mobile terminals, the request message instructing the GPRS to delete the PDP Contexts related to the failed or shutdown GTP-U.

13. The GGSN claimed in claim 8, wherein following deletion of the PDP contexts, the GTP-C/m sends a Route Update request to a Routing Engine (RE) for requesting a route update of routes related to lost data sessions supported by the failed or shutdown GTP-U.

14. A method for replacing a failed data session processing unit (GTP-U) supporting one or more data sessions for mobile terminals on a Gateway General Packet Radio Service (GPRS) Support Node (GGSN), the method comprising the steps of:
i) detecting a failure or a shutdown of the GTP-U of the GGSN;
ii) activating a spare GTP-U of the GGSN; and
iii) rebuilding the plurality of data sessions on the spare GTP-U.

15. The method claimed in claim 14, wherein the step of detecting a failure or a shutdown of one of the GTP-Us is performed at least partially by a master data session control unit (GTP-C/m) of the GGSN.

16. The method claimed in claim 14, wherein the step of detecting a failure or a shutdown of one of the GTP-Us comprises the step of:
receiving in the GTP-C/m a Failure Detection message indicative of the failure or shutdown of the GTP-U.

17. The method claimed in claim 14, further comprising the steps of:
detecting if the GGSN comprises a spare, non-utilized, GTP-U unit; and
if the GGSN comprises a spare, non-utilized, GTP-U unit, performing steps ii) and iii).

18. The method claimed in claim 15, wherein step iii) comprises the steps of:
transmitting a failed GTP-U rebuild request from the GTP-C/m to each data session control unit (GTP-C/s) of the GGSN that controlled the one or more data sessions;
responsive to the GTP-U rebuild request, sending from each GTP-C/s to the spare GTP-U, information related to the Packet Data Protocol (PDP) Context of the one or more data sessions, the information being used by the spare GTP-U to rebuild the one or more data sessions previously supported by the failed GTP-U.

19. The method claimed in claim 18, wherein the information is sent in a plurality of Spare GTP-U Activate Session messages, each one of the plurality of messages comprising one PDP context of one data sessions of the one or more data sessions.

20. The method claimed in claim 14, wherein following the step iii), the method further comprises the step of:
sending a Route Update message from the GTP-C/m to a Routing Engine for requesting a route update of routes related to lost data sessions supported by the failed or shutdown GTP-U.

21. A Gateway General Packet Radio Service (GPRS) Support Node (GGSN) comprising:
a plurality of data sessions processing units (GTP-Us) for supporting one or more data sessions for mobile terminals;
a plurality of data session control units (GTP-C/s) for controlling the one or more data sessions;
a master control unit (GTP-C/m) of the GGSN detecting a failure or a shutdown of one of the GTP-Us;
wherein when the GTP-C/m detects the failure or the shutdown of one of the GTP-Us, it activates a spare GTP-U of the GGSN and instructs rebuilding the one or more data sessions on the spare GTP-U.

22. The GGSN claimed in claim 21, wherein the GTP-C/m receives a Failure Detection message indicative of the failure or shutdown of the GTP-U.

23. The GGSN claimed in claim 21, further wherein the GTP-C/s detects if the GGSN comprises a spare, non-utilized, GTP-U unit, and if so, activates the spare GTP-U of the GGSN and instructs rebuilding the one or more data sessions on the spare GTP-U.

24. The GGSN claimed in claim 21, wherein for rebuilding the one or more data sessions on the spare GTP-U, the GTP-C/m transmits a failed GTP-U rebuild request to each GTP-C/s of the GGSN that controlled the one or more data sessions, and responsive to the GTP-U rebuild request, each GTP-C/s send to the spare GTP-U information related to the Packet Data Protocol (PDP) Context of the one or more data sessions, the information being used by the spare GTP-U to rebuild the one or more data sessions previously supported by the failed GTP-U.

25. The GGSN claimed in claim 24, wherein the information is sent in a plurality of Spare GTP-U Activate Session messages, each one of the plurality of messages comprising one PDP context of one data sessions of the one or more data sessions.

26. The GGSN claimed in claim 21, wherein following the one or more data sessions on the spare GTP-U, the GTP-C/m sends a Route Update message from the GTP-Cm to a Routing Engine for requesting a route update of routes related to lost data sessions supported by the failed or shutdown GTP-U.
